(19) United States
(12) Patent Application Publication
(10) Pub. No.: US 2025/0144599 A1
(43) Pub. Date: May 8, 2025

(54) ANTIMICROBIAL WATER-ABSORBENT CROSS-LINKED POLYMERIC POLYCARBOXYLIC ACID AND RELATED METHODS

(71) Applicant: Ecovia Renewables inc., Ann Arbor, MI (US)

(72) Inventor: Chao PENG, Ann Arbor, MI (US)

(21) Appl. No.: 18/835,690

(22) PCT Filed: Feb. 3, 2023
(86) PCT No.: PCT/US2023/061919

§ 371 Date: Aug. 2, 2024

Related U.S. Application Data
(60) Provisional application No. 63/307,002, filed on Feb. 4, 2022.

(51) Int. Cl. B01J 20/26; A01N 37/30; A01P 1/00; B01J 20/30; C08G 69/10; C08G 69/48

(52) U.S. Cl. CPC B01J 20/267; A01N 37/30; A01P 1/00; B01J 20/3085; C08G 69/10; C08G 69/48

(57) ABSTRACT

Disclosed are methods of preparing an antimicrobial cross-linked polymeric poly carboxylic acid with improved in-use stability and service life, by making a cross-linked polymeric polycarboxylic acid containing ammonium groups. Also disclosed are the antimicrobial cross-linked polymeric polycarboxylic acids made by the methods, antimicrobial water-absorbent cross-linked polymeric poly carboxylic acids made by the methods, and water-absorbent materials comprising the antimicrobial cross-linked polymeric poly carboxylic acids.

### CROSS REFERENCE TO RELATED APPLICATIONS

This application claims priority under 35 U.S.C. § 119 to U.S. Provisional Application No. 63/307,002 filed on Feb. 4, 2022. The entire contents of the aforementioned application are incorporated herein.

### FIELD OF THE INVENTION

This disclosed invention relates to antimicrobial cross-linked polymeric polycarboxylic acids and antimicrobial water-absorbent materials, and methods related to the composition, manufacture, and use thereof.

### BACKGROUND

Water-absorbent polymers, which absorb water or aqueous fluid and hold it in the form of a gel, have been used in many applications, such as for hygiene products like disposable diapers, agricultural products like soil amendments, and other applications in which absorption, retention, or delivery of water is useful.

Traditionally such water-absorbent materials have been made of synthetic petroleum-based polymers such as the sodium salt of poly(acrylic acid) and polyacrylamide that are cross-linked into water insoluble networks that can absorb water to form hydrogels. Although relatively inexpensive, petroleum-based polymers have a negative impact on the environment due, among other things, to their non-renewable and non-degradable natures and regulated emissions generated from the processes for obtaining their constituent monomers from petroleum sources.

A renewable alternative to such traditional absorbent polymeric materials is absorbent materials using bio-based polymers that are renewable and biodegradable, such as poly(amino acid) and polysaccharide. For example, gamma-poly(glutamic acid) (γ-PGA) is a water-soluble polymeric polycarboxylic acid that can be commercially manufactured by a microbial fermentation process. γ-PGA has a hydrophilic polyamide backbone, and like poly(acrylic acid), it has a pendent carboxylic acid functional group in each repeating unit. These features make it suitable for cross-linking into a material for use in absorbent applications. For example, γ-PGA can be cross-linked by glycidyl ether cross-linkers such as ethylene glycol diglycidyl ether and trimethylolpropane triglycidyl ether to form a water-absorbent product. However, bio-based absorbent materials, such as poly(amino acid) and polysaccharide, usually suffer from high enzymatic degradation rate induced by microbes, which limits their uses for applications that require long-term in-use stability.

Therefore, the methods, and compositions thereof, for making cross-linked bio-based absorbent materials with reduced degradation rate are needed, which provide long-term in-use stability in various applications.

### SUMMARY

Disclosed are methods of preparing an antimicrobial cross-linked polymeric polycarboxylic acid with improved in-use stability and service life, by making a cross-linked polymeric polycarboxylic acid containing ammonium groups. Also disclosed are the antimicrobial cross-linked polymeric polycarboxylic acids made by the methods, antimicrobial water-absorbent cross-linked polymeric polycarboxylic acids made by the methods, and water-absorbent materials comprising the antimicrobial cross-linked polymeric polycarboxylic acids.

### BRIEF DESCRIPTION OF THE FIGURE

FIG. 1 is a graphical illustration of formula for component polymers comprising embodiments herein. “A” represents the structural unit of the polymer backbone, “C” represents the carboxyl group, “X” represents the linkage between the polymer backbone and the carboxyl group, “B” represents the ammonium group, “Y” represents the linkage between the polymer backbone and the ammonium group, and “Z” represents the linkage between the polymer chains.

### DETAILED DESCRIPTION

“A,” “an,” “the,” “at least one,” and “one or more” are used interchangeably to indicate that at least one of the item is present; a plurality of such items may be present unless the context clearly indicates otherwise. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups thereof. As used in this specification, the term “or” includes any and all combinations of one or more of the associated listed items. A “water-soluble” polymer is a polymer that can be combined with water, with or without the presence of co-solvents and/or neutralizing agents, to form transparent solutions. A “water-dispersible” polymer is a polymer that can be combined with water, with or without the presence of co-solvents, neutralizing agents, or any combination thereof, to form a stable dispersion. A dispersion that has no visible settled sedimentation after twenty four (24) hours storage at twenty five (25) degrees Celsius (° C.) may be considered to be stable.

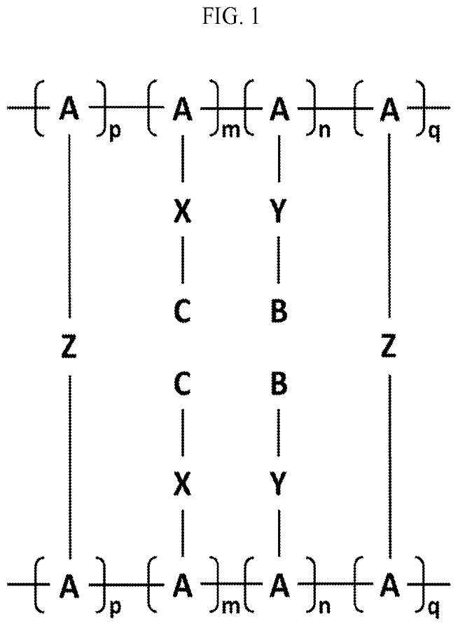

FIG. 1 represents a formula for cross-linked polycarboxylic acid functionalized with ammonium groups. In FIG. 1: “A” represents the structural unit of the polymer backbone, “C” represents the carboxyl group, “X” represents the linkage between the polymer backbone and the carboxyl group, “B” represents the ammonium group, “Y” represents the linkage between the polymer backbone and the ammonium group, and “Z” represents the linkage between the polymer chains.

Various embodiments herein are cross-linked polymers comprising components represented by FIG. 1 such as cross-linked polymers made using methods disclosed herein. It should be noted that in many embodiments, the final polymeric structure is randomly cross-linked and functionalized, and the structure may not feasibly be determinable by standard analytic methods. Regardless, materials with desired properties have been found to be achieved by a cross-linked polymer having, in the molecule thereof, structures represented by the formula represented in FIG. 1.

### Compositions

An antimicrobial cross-linked polymeric polycarboxylic acid is prepared by reacting a polymeric polycarboxylic acid with a polyepoxide cross-linker and a glycidyl ammonium compound, and this reaction provides a cross-linked polymeric polycarboxylic acid functionalized with ammonium groups. The incorporation of ammonium groups is discovered to slow down the degradation of the water-absorbent materials herein. Even though there are examples in literature showing that ammonium groups may provide antimicrobial properties to some polymers, one cannot predict the effect of ammonium groups on any particular polymers. To develop an antimicrobial polymer, it requires extensive research and trial and error, as the antimicrobial activity of the polymers is affected by multiple factors, including hydrophilic-hydrophobic balance of the polymer, backbone structure of the polymer, pendant groups of the polymer, molecular weight of the polymer, presence of hydrogen bonding, self-assembly behavior of the polymer, type of the ammonium groups and their counterions, etc.

The polymeric polycarboxylic acid is a polymer having carboxylic acid pendant groups along the polymer backbone. In some embodiments, the polymeric polycarboxylic acid has a carboxylic acid group on one end, on both ends, or some combination thereof. In various embodiments, the polymeric polycarboxylic acid has a carboxylic acid group pendent from every monomer unit to, on average, a carboxylic acid group pendent from about every tenth monomer unit; or pendent from every monomer unit to, on average, pendent from about every sixth monomer unit; or pendent from every monomer unit to, on average, pendent from about every fifth monomer unit; or pendent from every monomer unit to, on average, pendent from about every fourth monomer unit; or pendent from every monomer unit to, on average, pendent from about every third monomer unit; or pendent from every monomer unit to, on average, pendent from about every other monomer unit; or pendent from every monomer unit.

In various embodiments, the weight-average molecular weight of the polymeric polycarboxylic acid is from about one (1) kiloDalton (kDa) to about fifty thousand (50,000) kDa, preferably from about five (5) kDa to about fifty thousand (50,000) kDa, more preferably from about one hundred (100) kDa to about five thousand (5,000) kDa, and still more preferably from about two hundred (200) kDa to about six hundred (600) kDa, as determined by gel permeation chromatography (GPC) equipped with a light scattering detector. In various embodiments, the weight-average molecular weight of the polymeric polycarboxylic acid is from about one (1) kDa or from about five (5) kDa or from about ten (10) kDa or from about twenty (20) kDa or from about thirty (30) kDa or from about fifty (50) kDa or from about one hundred (100) kDa or from about one hundred fifty (150) kDa or from about two hundred (200) kDa or from about two-hundred fifty (250) kDa or from about three hundred (300) kDa up to about five hundred (500) kDa or up to about five hundred fifty (550) kDa or up to about six hundred (600) kDa or up to about seven hundred (700) kDa or up to about eight hundred (800) kDa or up to about nine hundred (900) kDa or up to about one thousand (1000) kDa or up to about two thousand (2000) kDa or up to about five thousand (5000) kDa or up to about seven thousand five hundred (7500) kDa or up to about ten thousand (10,000) kDa or up to about fifteen thousand (15,000) kDa or up to about twenty thousand (20,000) kDa or up to about twenty five thousand (25,000) kDa or up to about thirty thousand (30,000) kDa or up to about forty thousand (40,000) kDa or up to about fifty thousand (50,000) kDa, or combinations thereof. The polymeric polycarboxylic acid preferably contains a sufficient number of carboxylic acid groups to be water-soluble or water-dispersible. In certain embodiments, the average number of carboxylic acid groups per polymeric polycarboxylic acid chain is from about two (2) to about seven hundred thousand (700,000), preferably from about fifty (50) to about fifty thousand (50,000), and more preferably from about one thousand five hundred (1,500) to about eight thousand (8,000).

Nonlimiting examples of suitable polycarboxylic acid polymers for cross-linking include homopolymers and copolymers of ethylenically unsaturated carboxylic acids such as acrylic acid, methacrylic acid, 2-ethacrylic acid, 2-propylacrylic acid, crotonic acid, itaconic acid, maleic acid, fumaric acid, and the like, as well as salts and anhydrides of these; carboxymethyl cellulose and salts thereof; polyaspartic acids and salts thereof; polyglutamic acids and salts thereof; and carboxyethyl dextran and salts thereof. In certain embodiments, the polycarboxylic acid polymer is selected from the group consisting of: α-poly(glutamic acid), g-poly(glutamic acid), α-poly(aspartic acid), β-poly(aspartic acid), carboxymethyl cellulose, poly(acrylic acid), poly(methacrylic acid), poly(2-carboxyethyl acrylate), poly(2-ethylacrylic acid), poly(2-propylacrylic acid), poly(maleic acid), their copolymers, and combinations thereof. In certain embodiments, the polymeric polycarboxylic acid comprises a poly(amino acid), for example a homopolymer of aspartic or glutamic acid such as L-α-poly(aspartate) or L-α-poly(glutamate) or combinations thereof produced through a ribosomal translation method. Other nonlimiting examples of poly(amino acids) used in various embodiments include: D,L-(α,β)-poly(aspartate) or D,L-(α, γ)-poly(glutamate) or combinations thereof produced from aspartic acid, glutamic acid monomers, or combinations thereof, through condensation polymerization; or D-γ-poly(glutamate), L-γ-poly(glutamate), D,L-γ-poly(glutamate) or any combination thereof produced through non-ribosomal synthesis in a microbial fermentation or in vitro biochemical method. The polycarboxylic acid polymer may be used in any combination in the cross-linking process.

In addition to the polymeric polycarboxylic acid or combination of polymeric polycarboxylic acids, in various embodiments the reaction further comprises a second polymer having a plurality of groups reactive with the cross-linking agent, for example a plurality of reactive groups selected from the group consisting of carboxylic acid groups, amine groups, hydroxyl groups, and combinations thereof. In various embodiments, the second polymer is water soluble or water dispersible. Nonlimiting examples of polymers suitable as the second polymer include starch, guar gum, xanthan gum, carrageenan, pectin, glucomannan, inulin, cellulose, β-glucan, dextrin, galactomannan, alginic acid, chitosan, homopolymers and copolymers of ethylenically unsaturated carboxylic acids, amines, and alcohols, such as acrylic acid, methacrylic acid, 2-ethacrylic acid, 2-propylacrylic acid, acrylamide, 2-hydroxyethyl acrylate, N-(2-hydroxyethyl) acrylamide, maleic acid, and 2-aminoethyl methacrylate, and combinations of such polymers.

In addition to a glycidyl ammonium compound, in some embodiments the reaction further comprises an ammonium group containing water soluble or water-dispersible polymer having a plurality of groups reactive with the cross-linker, for example a plurality of reactive groups selected from the group consisting of hydroxyl groups, carboxylic acid groups, amine groups, and combinations thereof. Nonlimiting examples of suitable polymers include ammonium modified cellulose, starch, guar gum, chitosan, xanthan gum, pectin, carrageenan, and konjac glucomannan.

In some embodiments, instead of reacting the polymeric polycarboxylic acid or combination of polymeric polycarboxylic acids with polyepoxide cross-linker and glycidyl ammonium compound simultaneously, the reaction is carried out stepwise. In some such embodiments, the polymeric polycarboxylic acid or combination of polymeric polycarboxylic acids is first reacted with glycidyl ammonium compound and then reacted with polyepoxide cross-linker. In other such embodiments, the polymeric polycarboxylic acid is first reacted with polyepoxide cross-linker and then reacted with glycidyl ammonium compound.

Depending on the reactivity of the glycidyl ammonium compound, the ammonium group of the glycidyl ammonium compound is, in some embodiments, protected prior to the cross-linking reaction and then deprotected afterwards. For example, the ammonium group of the glycidyl ammonium compound is protected when it is primary amine or secondary amine, since the compound reacts with itself during the cross-linking process. The ammonium group of the glycidyl ammonium compound can be protected using common amino-protecting groups, such as 9-fluorenylmethyl carbamate, t-butyl carbamate, benzyl carbamate, acetamide, trifluoroacetamide, etc. The protecting groups can be deprotected after the cross-linking process.

Suitable polyepoxide cross-linking molecules contain two or more reactive epoxide groups. Nonlimiting examples of these include, but are not limited to, polyglycidyl ethers of alkanepolyols and poly(alkylene glycols), including, for further example, ethylene glycol diglycidyl ether, diethylene glycol diglycidyl ether, polyethylene glycol diglycidyl ether, glycerine diglycidyl ether and triglycidyl ether, propylene glycol diglycidyl ether, butanediol diglycidyl ether, and polyglycidyl ethers of erythritol, trimethylolethane, pentaerythritol, and trimethyolpropane; diepoxyalkanes and diepoxyaralkanes, including, 1,2,3,4-diepoxybutane, 1,2,4,5-diepoxypentane, 1,2,5,6-diepoxyhexane, 1,2,7,8-diepoxyoctane, 1,4- and 1,3-divinylbenzene diepoxides; polyphenol polyglycidyl ethers, including, for further example, 4,4′-isopropylidenediphenol diglycidyl ether (bisphenol A diglycidyl ether) and hydroquinone diglycidyl ether; and polyglycidyl esters of polycarboxylic acids such as oxalic acid diglycidyl ester, succinic acid diglycidyl ester, adipic acid diglycidyl ester, glutaric acid diglycidyl ester, phthalic acid diglycidyl ester, terephthalic acid diglycidyl ester, hexahydrophthalic acid diglycidyl ester, 2,6-napthalenedicarboxylic acid diglycidyl ester, as well as epoxide esters of polyunsaturated fatty acids and their oliogomers, such polyepoxidized dimerized linolenic acid, polyepoxidized linoleic acids, polyepoxidized linolenic acids including the polyepoxided derivatives of linseed oil, soybean oil, alkyl esters of these, and oligomers of these.

Nonlimiting examples of suitable glycidyl quaternary ammonium compounds include but are not limited to: glycidyltrimethylammonium chloride (GTMAC), glycidyltriethylammonium chloride (GTEAC), N-glycidyl-N,N-dimethyl-N-ethylammonium chloride (GDMEAC), and N-glycidyl-N,N-dimethyl-N-cetylammonium chloride (GDMCetAC), tert-butyl N-(2-oxiranylmethyl) carbamate, and combinations thereof.

In certain embodiments, the amount of polyepoxide cross-linker used in the reaction is preferably from about one tenth (0.1) to about ten (10) wt %, more preferably from about three tenths (0.3) to about five (5) wt %, and even more preferably from about five tenths (0.5) to about two (2) wt % based on the weight of the polymeric polycarboxylic acid.

In certain embodiments, the amount of glycidyl quaternary ammonium compound used in the cross-linking reaction is preferably from about one (1) to about fifty (50) wt %, more preferably from about two (2) to about thirty (30) wt %, and even more preferably from about five (5) to about twenty (20) wt % based on the weight of the polymeric polycarboxylic acid.

### Methods

In an example embodiment, all the components for the reaction are dissolved in an aqueous medium and the reaction solution is heated in an oven. The concentration of the polymeric polycarboxylic acid in the reaction solution is, in some such embodiments, from about ten (10) to about three hundred (300) grams per liter (g/L), preferably from about fifty (50) to about two hundred (200) g/L, and more preferably from about eighty (80) to about one hundred fifty (150) g/L. The pH of the reaction solution is, in various embodiments, from about three (3) to about nine (9), preferably from about four (4) to about eight (8), and more preferably from about five (5) to about seven (7). Useful neutralizing agents include alkali metal bases, ammonia, amines, or combinations thereof. The oven temperature is, in some embodiments, from about fifty (50) to about two hundred (200)° C., preferably from about eighty (80) to about one hundred eighty (180)° C., and more preferably from about one hundred (100) to about one hundred fifty (150)° C. The reaction mixture is, in some embodiments, kept in the oven from about one (1) to about twelve (12) hours, preferably from about one and two tenths (1.2) to about six (6) hours, and more preferably from about one and one-half (1.5) to about three (3) hours.

In various embodiments, drying is carried out in an oven, such as a forced air oven, at any of the oven temperatures given above, or with infrared heating at a temperature from about twenty (20) to about one hundred eighty (180)° C.

Nonlimiting examples of pulverizers include vertical pulverizers, grinders, rotary cutter mills, disc mills, and other such cutting, grinding, or crushing devices. In an example, the cross-linked polymeric polycarboxylic acid is further dried after a coarse pulverization, then ground or crushed, for example in a suitable mill, and classified to a final desired average particle size.

The reaction is, in some embodiments, carried out in an aqueous medium. The cross-linked polymeric polycarboxylic acid product is, in some such embodiments, then dried, pulverized, and classified to provide a particulate cross-linked polymeric polycarboxylic acid of a desired average particle size and/or particle size distribution. The pulverized, cross-linked polymeric polycarboxylic acid is not limited to any particular particle shape or geometry. In some embodiments, the particulate cross-linked polymeric polycarboxylic acid is in the form of a powder, flakes, agglomerates, granules, irregular granular particles, spheres, ellipsoids, cylindrically-shaped particles (or whiskers), fibers, or another shape or combination of shapes suitable for its intended use. This water-absorbent material can be used in many applications. For example, this material can be used in the absorbent core for baby diapers and adult hygiene products. This material can be used in a soil additive, as reservoir of water and nutrients, to release moisture and nutrients to the plant. This material can be used to dewater the coal fines after the coal preparation process to mitigate the negative impact of residual water on transportation costs, handling, and specific energy values. This material can be used as a medical device for drug delivery and tissue engineering. This material can be used as a thickener for aqueous media to increase the viscosity, including for personal care and food products. This material can also be used in other applications requiring absorption, desorption, or thickening of water or aqueous fluid.

In some embodiments, a soil amendment comprising cross-linked polymeric polycarboxylic acid disclosed herein, fertilizer, binder, etc., is processed into a form, such as small pellets to increase water absorption and retention of the soil. The cross-linked polymer disclosed herein provides sustained release of water, using bio-based and renewable sources instead of synthetics, with a useful life significantly longer than other renewable materials used in similar applications.

In some such embodiments, the soil amendment is in the form of dry pellets, the amendment is incorporated into commercially available potting soil, is provided as a bulk amendment for soil, other appropriate uses, and appropriate combinations thereof.

In some embodiments, the composition of particles of cross-linked polymeric polycarboxylic acid further comprises excipients, additives, or both that enhance performance or ease of use in end applications. The type of excipient or additive is not particularly limited. Suitable examples include, but are not limited to, other molecular species that are cross-linked with the polymeric polycarboxylic acid to alter material properties, surfactants or emulsifiers to enhance dispersion, inorganic fillers to enhance mechanical properties, coating the particles of cross-linked polymeric polycarboxylic acid with an active formulation ingredient, or impregnating the particles of cross-linked polymeric polycarboxylic acid with an active formulation ingredient.

Testing shows the antimicrobial cross-linked polymeric polycarboxylic acid exhibits improved stability compared to the one that doesn't contain ammonium groups. Without wishing to be bound to a particular theory, it is believed that the improved stability may be due to antimicrobial properties provided by the ammonium groups which disrupt the bacterial membrane.

This invention will be further described by the following examples. It should be noted that the working examples are provided for an illustration of the present invention, rather than intended to limit the scope of the present invention.

### EXAMPLES

In various embodiments, the weight-average molecular weight of the D,L-γ-poly(glutamic acid) used is two hundred fifty five (255) kDa (Mw), as determined by gel permeation chromatography equipped with a light scattering detector. In an experiment conducted using methods disclosed herein, The D,L-γ-poly(glutamic acid) (ten (10) g) was dispersed in DI water (one hundred (100) mL) with an immersion blender and the pH of the solution was adjusted to five and one half (5.5) by adding four (4) M HCl (one hundred (100) μL). Then, ethylene glycol diglycidyl ether (EGDGE) (one hundred (100) μL) and glycidyltrimethylammonium chloride (GTMAC) (one (1) mL) were added. The mixture was poured onto a silicon mat and heated at one hundred fifty (150)° C. for two (2) hours. After that, the product was ground to particles (twenty to one hundred (20-100) mesh).

For comparison, the cross-linked D,L-γ-poly(glutamic acid) was also prepared without using glycidyltrimethylammonium chloride (GTMAC) under the same condition. The D,L-γ-poly(glutamic acid) (ten (10) g) was dispersed in DI water (one hundred (100) mL) with an immersion blender and the pH of the solution was adjusted to five and one-half (5.5) by adding four (4) M HCl (one hundred (100) μL). Then, ethylene glycol diglycidyl ether (EGDGE) (one hundred (100) μL) was added. The mixture was poured onto a silicon mat and heated at one hundred fifty (150)° C. for two (2) hours. After that, the product was ground to particles (twenty to one hundred (20-100) mesh).

To determine the degradation rate of the cross-linked D,L-γ-poly(glutamic acid), four tenths (0.4) g of the sample was placed in a tea bag and mixed with twenty (20) mL of DI water. After five (5) min, the weight of the swollen sample was measured. Then, the swollen sample was buried under potting soil and incubated at thirty seven (37)° C. Every five (5) days, the sample was taken out from the potting soil, dried, and soaked in twenty (20) mL of DI water for five (5) min. The weight of the swollen sample was measured. The ratio between the weight of the swollen sample after incubation and the weight of the swollen sample before incubation was calculated as the degree of degradation.

A degradation study showed that cross-linked D,L-γ-poly(glutamic acid) containing ammonium groups mostly degraded after twenty (20) days, while the non-functionalized cross-linked D,L-γ-poly(glutamic acid) degraded within five (5) days, as shown below in Table 1.

TABLE 1

| | | Day | Day | Day | Day | Day |
|---|---|---|---|---|---|---|
| | | 0 | 5 | 10 | 15 | 20 |
| Non-function- | Weight (g) | 21.8 | 3.1 | 1.75 | 0.9 | 0.8 |
| alized Sample | Degradation (%) | 0 | 85.8 | 92.0 | 95.9 | 96.3 |
| Functionalized | Weight (g) | 21.5 | 21.1 | 18.9 | 5.8 | 1.6 |
| Sample | Degradation (%) | 0 | 1.9 | 12.1 | 73.0 | 92.6 |

The invention claimed has been herein disclosed sufficiently for persons skilled in the art to comprehend and practice. The various embodiments, examples, and illustrations disclosed herein, while representing the best and various alternative modes of carrying out the invention as currently contemplated by the inventors, are by no means limiting or exhaustive, but serve as an aid to comprehending the full nature and scope of the invention. Various other embodiments will become apparent which fall within the scope of this disclosure and claims.

What is claimed is:

1. A method of preparing an antimicrobial cross-linked polymeric polycarboxylic acid comprising reacting the polymeric polycarboxylic acid with a cross-linking agent and a glycidyl ammonium compound.

2. The method according to claim 1, wherein the cross-linking agent consists of a member selected from the group consisting of polyepoxides and combinations thereof.

3. The method according to claim 1, wherein the polymeric polycarboxylic acid has a carboxylic acid group pendent from every monomer unit to, on average, a carboxylic acid group pendent from about every tenth monomer unit.

4. The method according to claim 1, wherein the polymeric polycarboxylic acid has a weight-average molecular weight of from about 1 kDa to about 50,000 kDa.

5. The method according to claim 1, wherein the polymeric polycarboxylic acid contains a sufficient number of carboxylic acid groups to be water-soluble or water-dispersible.

6. The method according to claim 1, wherein the polymeric polycarboxylic acid has an average number of carboxylic acid groups per polymeric polycarboxylic acid chain from about 2 to about 700,000.

7. The method according to claim 1, wherein the polymeric polycarboxylic acid comprises a member selected from the group consisting of homopolymers and copolymers of ethylenically unsaturated carboxylic acids and salts and anhydrides thereof; carboxymethyl cellulose and salts thereof; polyaspartic acids and salts thereof; polyglutamic acids and salts thereof; and carboxylethyl dextran and salts thereof.

8. The method according to claim 1, wherein the polymeric polycarboxylic acid comprises a member selected from the group consisting of α-poly(glutamic acid), g-poly(glutamic acid), α-poly(aspartic acid), β-poly(aspartic acid), carboxymethyl cellulose, poly(acrylic acid), poly(methacrylic acid), poly(2-carboxyethyl acrylate), poly(2-ethylacrylic acid), poly(2-propylacrylic acid), poly(maleic acid), their copolymers, and combinations thereof.

9. The method according to claim 1, wherein the polymeric polycarboxylic acid comprises gamma-poly(glutamic acid).

10. The method according to claim 1, wherein the polymeric polycarboxylic acid is water-soluble or water-dispersible.

11. The method according to claim 1, wherein a second polymer having a plurality of groups reactive with the cross-linking agent is cross-linked with the polymeric polycarboxylic acid.

12. The method according to claim 1, wherein the polyepoxide is a member selected from the group consisting of ethylene glycol diglycidyl ether, diethylene glycol diglycidyl ether, propylene glycol diglycidyl ether, 1,3-butanediol diglycidyl ether, bisphenol A diglycidyl ether, bisphenol F diglycidyl ether, 1,4-butanediol diglycidyl ether, neopentyl glycol diglycidyl ether, resorcinol diglycidyl ether, glycerol diglycidyl ether, glycerol triglycidyl ether, poly(ethylene glycol) diglycidyl ethers, poly(propylene glycol) diglycidyl ethers, trimethylolpropane diglycidyl ether, trimethylolethane triglycidyl ether, triethylolpropane diglycidyl ether, triethylolethane triglycidyl ether, glycerol propoxylate triglycidyl ether, pentaerythritol tetraglycidyl ether, castor oil polyglycidyl ether, sorbitol polyglycidyl ether, polyglycerol polyglycidyl ether, and combinations thereof.

13. The method according to claim 1, wherein the glycidyl ammonium compound is a member selected from the group consisting of glycidyltrimethylammonium chloride (GTMAC), glycidyltriethylammonium chloride (GTEAC), N-glycidyl-N,N-dimethyl-N-ethylammonium chloride (GDMEAC), and N-glycidyl-N,N-dimethyl-N-cetylammonium chloride (GDMCetAC), tert-butyl N-(2-oxiranylmethyl) carbamate, and combinations thereof.

14. The method according to claim 1, wherein the cross-linking agent comprises from about 0.1 to about 10 wt % of the polyepoxide and/or from about 1 to about 50 wt % of the glycidyl ammonium compound based on the weight of the polymeric polycarboxylic acid.

15. The method according to claim 1, wherein the polymeric polycarboxylic acid reacts with cross-linking agent and glycidyl ammonium compound simultaneously or stepwise.

16. A cross-linked polymeric polycarboxylic acid made by the method of claim 1.

17. The cross-linked polymeric polycarboxylic acid according to claim 16 that is water-absorbent.

18. The water-absorbent material comprising the cross-linked polymeric polycarboxylic acid according to claim 17.

19. A cross-linked polymeric polycarboxylic acid which comprises:
(a) hydrophilic polymer chains with carboxyl groups
(b) ammonium groups
(c) cross-links between the polymer chains.

20. The cross-linked polymeric polycarboxylic acid of claim 19 wherein the hydrophilic polymer chain with carboxyl groups is gamma-poly(glutamic acid), and the ammonium groups are incorporated into the polymer by reacting the polymer with glycidyl ammonium compound.
